(19) United States
(12) Patent Application Publication
(10) Pub. No.: US 2013/0152899 A1
(43) Pub. Date: Jun. 20, 2013

(54) DUAL FUEL COMBUSTION SYSTEM BASED ON DIESEL COMPRESSION IGNITION TRIGGERED IGNITION CONTROL

(71) Applicant: Hyundai Motor Company, Seoul (KR)

(72) Inventors: Dae CHOI, Hwaseong-si (KR); Minyoung Ki, Seoul (KR); Seungil Park, Hwaseong-si (KR); Hyeungwoo Lee, Suwon-si (KR); Yohan Chi, Hwaseong-si (KR)

(73) Assignee: Hyundai Motor Company, Seoul (KR)

(21) Appl. No.: 13/712,705

(22) Filed: Dec. 12, 2012

(30) Foreign Application Priority Data
Dec. 15, 2011 (KR) 10-2011-0135573

(51) Int. Cl. F02M 69/04

(52) U.S. Cl. CPC F02M 69/04
USPC 123/445

(57) ABSTRACT

In a method for a diesel-gasoline dual fuel premixed charge compression ignition combustion system based on diesel compression ignition triggered ignition control of the present invention, air (+EGR gas) and a gasoline fuel supplied in a premixed charge intake stroke create a premixed surroundings, a diesel fuel injected in at least two classified steps in a succeeding compression ignition stroke creates a compression ignition combustion surroundings for a diesel and serves as an ignition trigger to produce flames, and the gasoline fuel injected in the premixed charge intake stroke and having created the premixed surroundings is burned in a succeeding combustion expansion stroke to generate power. Accordingly, a practical diesel-gasoline dual fuel powered engine solving both unstable combustion due to difficulty in control of ignition times and combustion and knockings restricting power performance can be realized.

### CROSS-REFERENCE TO RELATED APPLICATIONS

The present application claims priority of Korean Patent Application Number 10-2011-0135573 filed Dec. 15, 2011, the entire contents of which application is incorporated herein for all purposes by this reference.

### BACKGROUND OF INVENTION

1. Field of Invention

The present invention relates to a diesel-gasoline dual fuel premixed charge compression ignition combustion system which can solve a problem occurring when homogeneous charge compression ignition is applied through a method for the diesel-gasoline dual fuel premixed charge compression ignition combustion system based on diesel compression ignition triggered ignition control, and in particular, can be utilized by solving a knocking problem restricting power performance as well as an unstable combustion problem due to a difficulty in control of ignition timing and ignition in the diesel-gasoline dual fuel premixed charge compression ignition combustion system.

2. Description of Related Art

A solution for satisfying both exhaust gases and CO₂ gas regulations which are gradually becoming stricter and requirements for high fuel efficiency includes a method of realizing both advantages of a diesel engine and a gasoline engine.

For example, a method of increasing thermal efficiencies of fuels and increasing output power as well only through an ignition manner without changing a structure of an engine includes homogeneous charge compression ignition (HCCI) corresponding to homogeneous pre-mixed charge compression ignition.

A gasoline HCCI engine where the HCCI control method is applied to a gasoline engine can enhance fuel efficiency through compression ignition and lean burn ignition.

A diesel HCCI engine where the HCCI control method is applied to a diesel engine has an advantage of solving a trade-off phenomenon occurring during a PM/NOx producing and generating behavior through pre-mixed ignition and thus suppressing production and generation of PM/NOx.

However, considering a practical aspect of the above-mentioned HCCI control method, the HCCI control method has a limit very vulnerable as compared with a combustion method of a general gasoline engine and a combustion method of a general diesel engine in an aspect of stable security of combustion performance.

For example, it is difficult to control ignition timing and combustion in both the gasoline HCCI and the diesel HCCI in an aspect of unstable combustion. Further, power performance is limited by knockings in a high load region in the gasoline HCCI in an aspect of excessive increase of pressure exceeding an allowable range and it is very difficult to secure a product value due to combustion noise in the diesel HCCI. In addition, an exhaust trade-off phenomenon cannot be completely solved. In addition, the gasoline HCCI is accompanied by increase of NOx and the diesel HCCI is accompanied by increase of CO/HC.

In particular, since in both the gasoline HCCI and the diesel HCCI, available rotating speed (−3000 RPM) and brake mean effective pressure (BMEP; 4 to 6 bar) are limited to a low speed/low load condition in an aspect of operation applying region, there is disadvantageous restriction in that the operation region is very narrow when they are actually applied.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a diesel-gasoline dual fuel premixed charge compression ignition combustion system based on diesel compression ignition triggered ignition control are combined in an entire operation region thereof, and can easily secure ignition efficiency and stable combustion in a low-load region and prevent knockings in a high-load region as well, and a method for the diesel-gasoline dual fuel premixed charge compression ignition combustion system based on diesel compression ignition triggered ignition control.

Various aspects of the present invention provide for a diesel-gasoline dual fuel premixed charge compression ignition combustion system based on diesel compression ignition triggered ignition control, including: a high compression ratio combustion chamber having compression ratio between a gasoline compression ratio and a diesel compression ratio and formed between a cylinder block and a cylinder head located on a top thereof to form a stroke cycle due to reciprocal movement of a piston; a gasoline injector for injecting a gasoline fuel so that the gasoline fuel creates a premixed surroundings together with air and EGR gas supplied in a premixed charge intake stroke of the combustion chamber; a droplet diesel injector for injecting a diesel fuel so that diesel droplets are formed in a succeeding compression ignition stroke of the combustion chamber; or an ignition diesel injector for forming diesel flames to be served as an ignition trigger immediately after the injection of the fuel of the droplet diesel injector.

The diesel-gasoline dual fuel premixed charge compression ignition combustion system based on diesel compression ignition triggered ignition control may further include: an EGR system equipped with a turbo charger to supply an EGR gas together with air, wherein the droplet diesel injector and the ignition diesel injector further include a diesel fuel supply system for supplying a diesel fuel.

The droplet diesel injector and the ignition diesel injector may be realized by a single diesel injector so as to be controlled at different injection timings or one injection timing.

The high compression ratio combustion chamber may be shaped like a diesel combustion chamber and may maintain a compression ratio higher than that of a gasoline combustion chamber and maintains a compression ratio lower than that of a diesel combustion chamber.

The combustion chamber surroundings due to the diesel droplets may be created such that an ignition source is spatially uniformly distributed in the combustion chamber and accordingly propagation distances of gasoline flames are shortened relatively.

Various aspects of the present invention provide for a method for a diesel-gasoline dual fuel premixed charge compression ignition combustion system based on diesel compression ignition triggered ignition control, including a stroke cycle including: a premixed charge intake stroke completed at the premixed charge intake stroke completing time point after a premixed surroundings of a combustion chamber for premixed charge compression ignition is started by supplying a gasoline fuel mixed with air and EGR gas into the combustion chamber at the premixed charge intake stroke starting time point; a compression ignition stroke starting at the premixed charge intake stroke completing time point, where after a diesel fuel is injected into the combustion chamber until a time point before compression ignition, or a diesel fuel is injected once again into the combustion chamber at a compression ignition time point; a combustion expansion stroke where the gasoline fuel supplied into the combustion chamber is ignited by injection of a diesel fuel and flames of the gasoline fuel propagate into a space of the combustion chamber; and an exhaust stroke returning to the premixed charge intake stroke, where combustion gas generated after the gasoline fuel is burned is discharged to the outside.

In the premixed charge intake stroke, an EGR gas may be injected together with the air and the gasoline fuel and the gasoline fuel may be mixed in a mixed state of the air and the EGR gas.

The injection of the gasoline fuel in the premixed charge intake stroke may be performed outside a cylinder head port by a gasoline injector.

The injection of the diesel fuel may form diesel droplets such that an ignition source is spatially uniformly distributed in the combustion chamber and propagation distances of gasoline flames are shortened relatively, whereas the another injection of a diesel fuel may serve as an ignition trigger creating flames in the combustion chamber to form a combustion time point.

The injection of the diesel fuel may be performed by directly injecting the diesel fuel into the combustion chamber using a droplet diesel injector or the another injection of the diesel fuel may be performed by directly injecting a diesel fuel into the combustion chamber using an ignition diesel injector.

The droplet diesel injector and the ignition diesel injector may be realized by a single diesel injector so as to be controlled at different injection timings or one injection timing.

According to the present invention, a method for a diesel-gasoline dual fuel premixed charge compression ignition combustion system based on diesel compression ignition triggered ignition control is managed to easily secures ignition efficiency at a low-load region and prevent HCCI knockings in a high-load region, thereby making it possible to early practice the diesel-gasoline dual fuel premixed charge compression ignition combustion system based on diesel compression ignition triggered ignition control.

According various aspects of the present invention, since the method for a diesel-gasoline dual fuel premixed charge compression ignition combustion system based on diesel compression ignition triggered ignition control which is practical is applied to the diesel-gasoline dual fuel premixed charge compression ignition combustion system, unstable combustion due to difficulty in control of ignition timings and combustion can be prevented. Further, knockings restricting power performance is prevented and an excessive increase of a pressure causing combustion noise directly lowering product value is prevented. In addition, an exhaust trade-off phenomenon causing increase of NOx and CO/HC is prevented. In addition, a limit in a very narrow operation region can be completely solved by solving a limit in a low speed/low load condition such as a region of an engine RPM of approximately 3000 RPM and a brake mean effective pressure (BMEP) of 4 to 6 bar.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an exemplary diesel-gasoline dual fuel premixed charge compression ignition combustion system, to which method for a diesel-gasoline dual fuel premixed charge compression ignition combustion system based on diesel compression ignition triggered ignition control is applied according to the present invention.

FIGS. 2A and 2B are flowcharts showing an exemplary method for a diesel-gasoline dual fuel premixed charge compression ignition combustion system based on diesel compression ignition triggered ignition control according to the present invention.

FIGS. 3A, 3B, 3C and 3D are views showing a stroke cycle of an exemplary diesel-gasoline dual fuel powered engine to which an exemplary method for a diesel-gasoline dual fuel premixed charge compression ignition combustion system based on diesel compression ignition triggered ignition control is applied according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

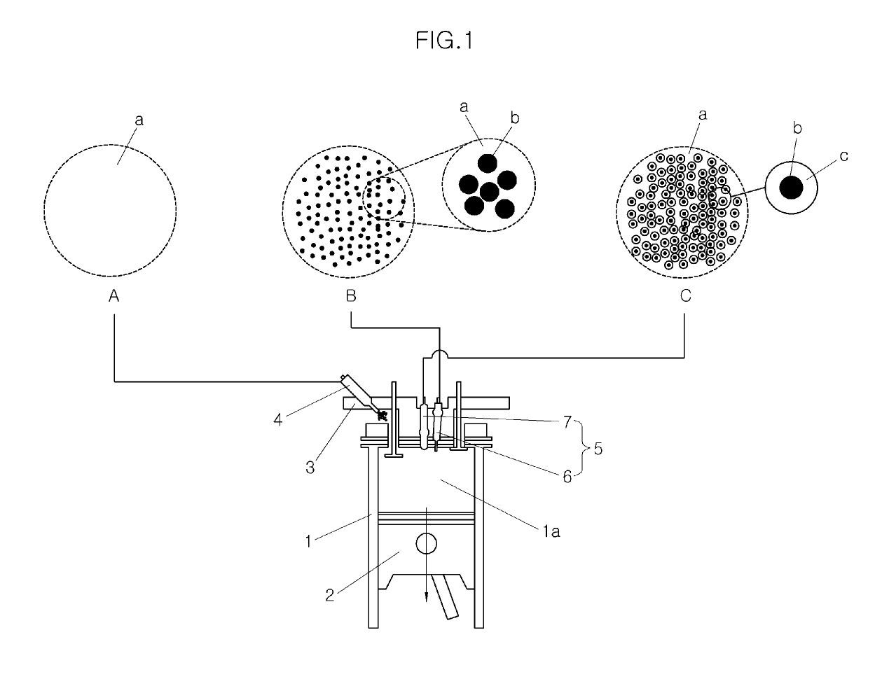

FIG. 1 shows a diesel-gasoline dual fuel premixed charge compression ignition combustion system based on diesel compression ignition triggered ignition control, to which method for a diesel-gasoline dual fuel premixed charge compression ignition combustion system based on diesel compression ignition triggered ignition control is applied.

The diesel-gasoline dual fuel premixed charge compression ignition combustion system based on diesel compression ignition triggered ignition control includes a combustion chamber 1a formed between a cylinder block 1 and a cylinder head 3 located at the top thereof, a gasoline injector 4 for injecting a gasoline fuel during a premixed charge intake stroke of combustion chamber 1a so that the gasoline fuel creates a premixed surroundings together with supplied air, and a diesel injector 5 for injecting a diesel fuel in at least two steps into which a compression ignition stroke succeeding the premixed charge intake stroke is classified.

Combustion chamber 1a employs a combustion chamber type capable of forming a stroke cycle due to reciprocal movement of a piston 2, and in particular, realizing a high compression ratio, and to this end, has a shape of a diesel combustion chamber and has a compression ratio of 8 to 12 which is higher than that of a general gasoline engine.

An example of combustion chamber 1a includes a combustion chamber whose combustion speed can be enhanced through a highly turbulent bulk type combustion swirling mechanism.

Gasoline is premixed in the premixed charge intake stroke and a compression ignition method for a diesel is combined in the compression ignition stroke for more stable ignition.

The diesel fuel injection timings of diesel injector 5 classified into two steps are realized through a droplet diesel injector 6 which injects a diesel fuel for forming diesel droplets in a succeeding compression ignition stroke of the combustion chamber, and an ignition diesel injector 7 which injects a diesel fuel serving as an ignition trigger after the diesel fuel of droplet diesel injector 6 is injected to form flames.

However, when diesel injector 5 actually injects a diesel fuel to form diesel droplets, diesel injector 5 is referred to as droplet diesel injector 6, whereas when diesel injector 5 injects a diesel fuel serving as an ignition trigger, diesel injector 5 is referred to as ignition diesel injector 7.

In various embodiments of the present invention, one diesel injector 5 is classified into droplet diesel injector 6 and ignition diesel injector 7 so that the diesel fuel injection timings classified into two steps can be explained more easily, and although it will be described that diesel injector 5 is classified into droplet diesel injector 6 and ignition diesel injector 7 in the following description, it means that one diesel injector 5 only has different functions.

The fuel injection timings of gasoline injector 4, droplet diesel injector 6, and ignition diesel injector 7 are controlled by an ECU (Engine Control Unit) for controlling an engine and a vehicle on the whole.

The diesel-gasoline dual fuel premixed charge compression ignition combustion system based on diesel compression ignition triggered ignition control further includes an EGR system equipped with a turbo charger to supply an EGR gas together with air, and the droplet diesel injector and the ignition diesel injector further include a diesel fuel supply system for supplying a diesel fuel and a swirl control system for forming swirls for the air, the EGR gas, the gasoline fuel, and the diesel fuel in the combustion chamber.

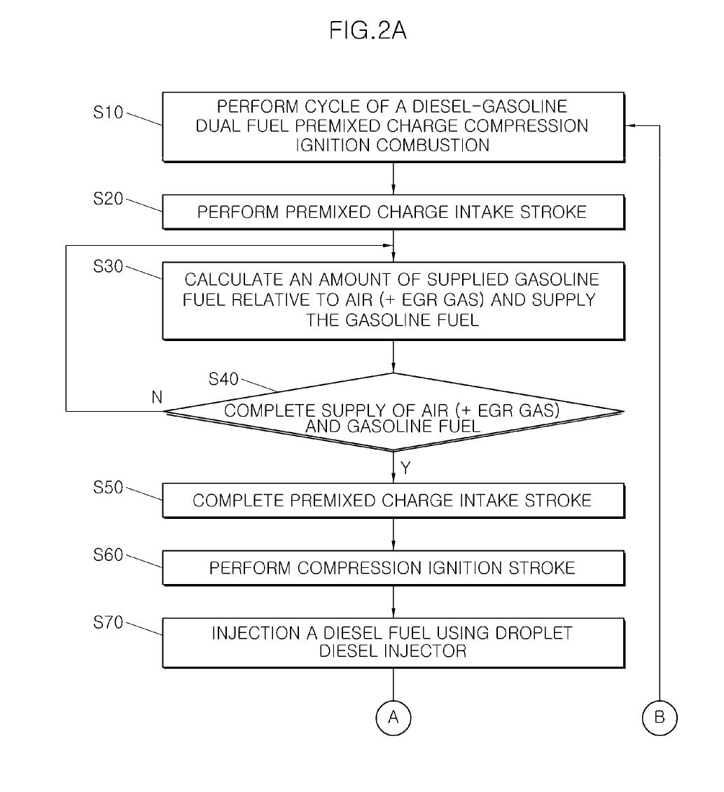

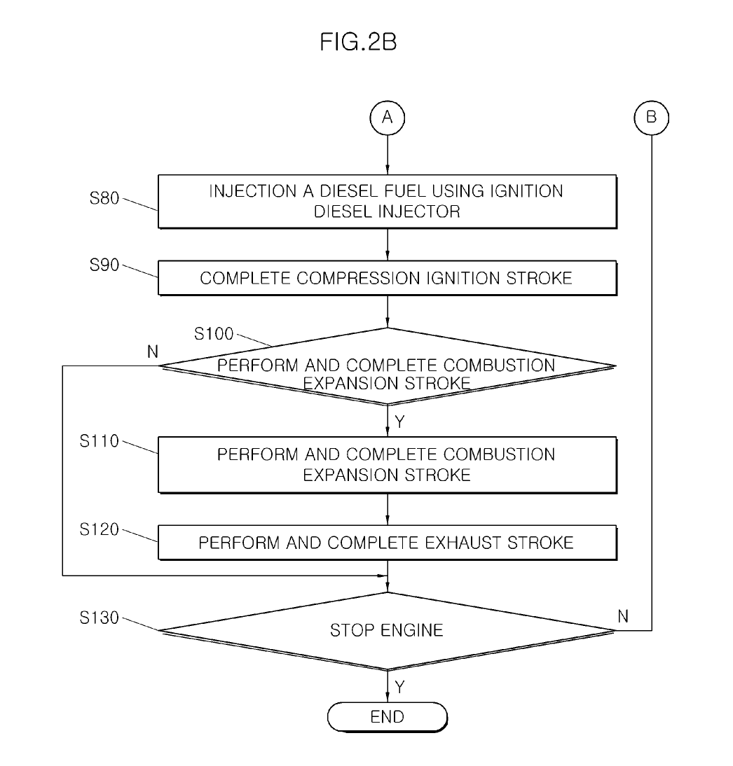

Meanwhile, referring to FIGS. 2A and 2B, step S10 means that a diesel-gasoline dual fuel premixed charge compression ignition combustion system based on diesel compression ignition triggered ignition control, to which method for a diesel-gasoline dual fuel premixed charge compression ignition combustion system based on diesel compression ignition triggered ignition control is applied.

Next, after a premixed charge intake stroke of step S20, a compression ignition stroke of step S60, and a combustion expansion stroke of step S110 are sequentially performed, one stroke cycle is completed via an exhaust stroke of step S120.

The above-mentioned one stroke cycle is repeated as long as the engine is operated.

If the premixed charge intake stroke of step S20 is performed, the premixed charge intake stroke is performed through step S40 succeeding step S30.

Then, the gasoline fuel is injected under the control of gasoline injector 4.

The premixed charge gas intake stroke is performed until a target value is determined by calculating an amount of the gasoline fuel required relative to an amount of supplied air as in step S30 and the supply of air and the injection of the gasoline fuel carried out accordingly satisfies the target value as in step S40.

Although the premixed charge gas intake stroke may be performed through the supply of air and the injection of the gasoline fuel, an EGR (Exhaust Gas Recirculation) gas may further be applied in the gasoline premixed charge intake stroke performed according to various embodiments of the present invention to lessen or prevent knockings in a high-load region.

As a concentration of exhaust gas in a combustion chamber increases, a temperature of burning flames becomes lower and a concentration of oxygen becomes lower, so the EGR gas can reduce an amount of nitrogen oxide easily produced in a high-temperature condition and a high oxygen concentration condition and lessen knockings in a high-load region as well.

Accordingly, the premixed charge intake stroke through the supply of the air, the EGR gas, and the injection of the gasoline fuel is performed in step S30 and step S40 succeeding the premixed charge intake stroke of step S20, in which an amount of the gasoline fuel is calculated as a ratio with respect to an amount of the air and the EGR gas and an amount of the EGR gas is calculated as a ratio with respect to an amount of air.

A relative ratio of the air, the EGR gas, and the gasoline fuel of the premixed charge intake stroke according to step S20 to step S40 described above may become different according to a condition such as a specification of the engine, and is not limited to a specific value.

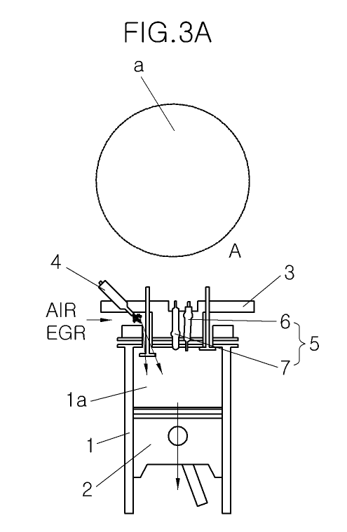

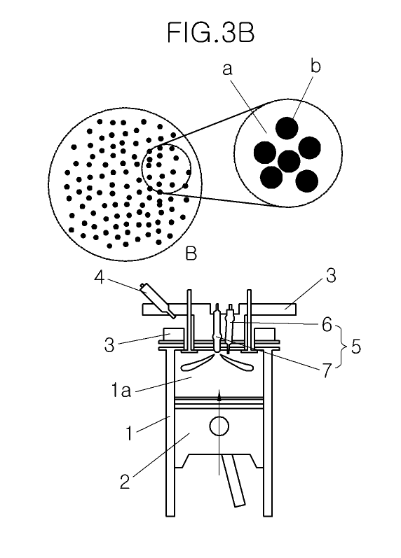

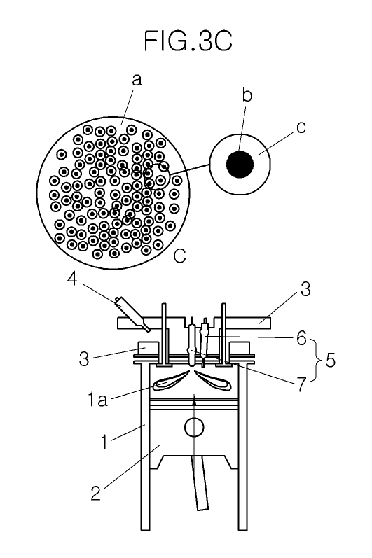

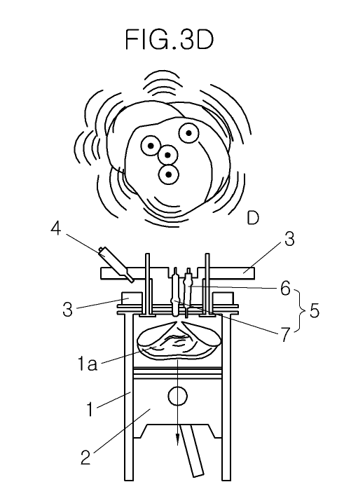

If the above-mentioned premixed charge intake stroke for premixing gasoline is completed as in step S50, a premixed atmosphere A is formed in combustion chamber 1a as shown in FIG. 3A.

Gasoline premixed atmosphere A refers to an air/gasoline fuel mixed state a or an air/EGR gas/gasoline fuel mixed state a.

The premixed charge intake stroke performed in the above-mentioned way experimentally proved to significantly contribute to clean exhaust gas, excellent response, and silent operation.

Subsequently, a compression ignition stroke of step S60 immediately succeeds completion of the premixed charge intake stroke where gasoline is pre-mixed as in step S50.

The compression ignition stroke of S60 is performed while the compression ignition method for a diesel combined with premixing of gasoline is classified into two steps.

This includes an ignition stabilizing process immediately succeeding completion of the premixed charge intake stroke as in step S70 to form diesel droplets such that an ignition source is spatially distributed excellently in an interior of the combustion chamber and propagation distances of gasoline flames are shortened relatively, and a firing stabilizing process succeeding the ignition stabilizing process as in step S80 to serve as an ignition trigger for injecting a diesel fuel again and producing flames in the combustion chamber.

Referring to FIG. 3B, the ignition stabilizing process of step S70 includes a diesel droplet group surroundings B created during a compression ignition stroke using diesel.

This is directly injected into combustion chamber 1a using droplet diesel injector 6, but an amount of the diesel fuel becomes different according to a condition such as a specification of an engine, and thus it is not limited to a specific value.

Diesel droplet group surroundings B is a state where diesel fuel droplets b are uniformly distributed in an air/gasoline fuel (or air/EGR gas/gasoline fuel) mixed state a, and then a compression ignition combustion for a diesel can be combined with a gasoline premixed surroundings through this.

As diesel fuel droplets b creating diesel droplet group surroundings B are uniformly distributed within combustion chamber 1a in this way, diesel fuel droplets b are uniformly formed within an entire space of combustion chamber 1a in the compression ignition combustion surroundings C for a diesel in the following step.

As the firing stabilizing process of step S80 succeeding step S70 is performed in an atmosphere where a pressure of combustion chamber 1a is sufficient for generating firings, a diesel compression ignition combustion surroundings C other than diesel droplet group surroundings B is created and diesel compression ignition combustion surroundings C is created by a diesel fuel directly injected into combustion chamber 1a by using droplet diesel injector 6.

However, as an amount of the injected diesel fuel for diesel compression ignition combustion surroundings C becomes different according to a condition such as a specification of the engine, it is not limited to a specific value.

In diesel compression ignition combustion surroundings C, an unstable state of ignition can be solved by simultaneously creating a plurality of flames using diesel fuel droplets b uniformly distributed in combustion chamber 1a.

This means a substantial combustion state where the compression ignition combustion for a diesel is combined with the gasoline premixed atmosphere performed in the premixed charge intake stroke.

It has been experimentally proved that since the dual fuel premixed charge compression ignition combustion according to various embodiments of the present invention can solve an unstable state of ignition unlike the above-mentioned HCCI, it can prevent abrupt generation of heat during the succeeding combustion of gasoline and significantly contribute to prevention of knockings occurring at a high compression ratio.

Subsequently, in the expansion stroke of step S100 immediately succeeding the compression ignition stroke where ignitions are carried out in the compression ignition combustion for a diesel as in step S90, gasoline as well as a diesel fuel is burned to create a mixed combustion surroundings D as in FIG. 3D.

As such a mixed combustion surroundings D is created after a uniform and stable diesel ignition, it prevents abrupt generation of heat due to combustion of gasoline in combustion chamber 1a and solves an unstable state against combustion of gasoline.

As mentioned above, in the dual fuel premixed charge compression ignition combustion, as an expansion stroke is realized without abrupt generation of heat due to combustion of gasoline and an unstable state of combustion, it has been experimentally proved that an amount of discharged harmful exhaust gas is significantly reduced and fuel efficiency is significantly reduced as well.

Subsequently, one stroke cycle is completed as an exhaust stroke of step S120 starts after the expansion stroke as in step S110 is completed.

Exhaust gas is discharged in the exhaust stroke and a premixed charge intake stroke of step S20 immediately succeeds the exhaust stroke, thereby carrying out another one stroke cycle.

Meanwhile, step S130 means completion of control of the dual fuel premixed charge compression ignition combustion due to a stop of the engine.

As mentioned above, according to the method for a diesel-gasoline dual fuel premixed charge compression ignition combustion system based on diesel compression ignition triggered ignition control of various embodiments, air (+the EGR gas) and a gasoline fuel supplied in the premixed charge intake stroke create a premixed surroundings and the diesel fuel injected in two classified steps in the succeeding compression ignition stroke creates a compression ignition combustion surroundings of a diesel and serves as an ignition trigger to produce flames, and the gasoline fuel injected in the premixed charge intake stroke and having created a premixed atmosphere is burned in the succeeding combustion expansion stroke to generate power.

Therefore, a diesel-gasoline dual fuel premixed charge compression ignition combustion system based on diesel compression ignition triggered ignition control which solves an unstable state of combustion due to difficulty in control of ignition timing and combustion and knockings restricting power performance as well may be availably realized.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A diesel-gasoline dual fuel premixed charge compression ignition combustion system based on diesel compression ignition triggered ignition control, comprising:
a high compression ratio combustion chamber having a compression ratio between a gasoline compression ratio and a diesel compression ratio and formed between a cylinder block and a cylinder head located on a top thereof to form a stroke cycle corresponding to reciprocal movement of a piston;
a gasoline injector for injecting a gasoline fuel so that the gasoline fuel creates a premixed surrounding together with air and EGR gas supplied in a premixed charge intake stroke of the combustion chamber; and
a droplet diesel injector for injecting a diesel fuel so that diesel droplets are formed in a succeeding compression ignition stroke of the combustion chamber, or an ignition diesel injector for forming diesel flames to be served as an ignition trigger immediately after the injection of the fuel of the droplet diesel injector.

2. The system as defined in claim 1, further comprising:
an EGR system equipped with a turbo charger to supply an EGR gas together with air,
wherein the droplet diesel injector and the ignition diesel injector further include a diesel fuel supply system for supplying a diesel fuel.

3. The system as defined in claim 1, wherein the droplet diesel injector and the ignition diesel injector are realized by a single diesel injector so as to be controlled at different injection timings or one injection timing.

4. The system as defined in claim 1, wherein the high compression ratio combustion chamber is shaped like a diesel combustion chamber and maintains a compression ratio higher than that of a gasoline combustion chamber and maintains a compression ratio lower than that of a diesel combustion chamber.

5. The system as defined in claim 1, wherein the combustion chamber surroundings due to the diesel droplets is created such that an ignition source is spatially uniformly distributed in the combustion chamber and accordingly propagation distances of gasoline flames are shortened relatively.

6. A method for a diesel-gasoline dual fuel premixed charge compression ignition combustion system based on diesel compression ignition triggered ignition control, comprising a stroke cycle including:
a premixed charge intake stroke completed at an intake stroke completing time point after a premixed surroundings of a combustion chamber for premixed charge compression ignition is started by supplying a gasoline fuel mixed with air and EGR gas into the combustion chamber at the premixed charge intake stroke starting time point;
a compression ignition stroke starting at the premixed charge intake stroke completing time point, where after a diesel fuel is injected into the combustion chamber until a time point before compression ignition, or diesel fuel is injected once again into the combustion chamber at a compression ignition time point;
a combustion expansion stroke where the gasoline fuel injected into the combustion chamber is ignited by the another injection of the diesel fuel and flames of the gasoline fuel propagate into a space of the combustion chamber; and
an exhaust stroke returning to the premixed charge intake stroke, where combustion gas generated after the gasoline fuel is burned is discharged to the outside.

7. The method as defined in claim 6, wherein in the premixed charge intake stroke, an EGR gas is supplied together with the air and the gasoline fuel and the gasoline fuel is mixed in a mixed state of the air and the EGR gas.

8. The method as defined in claim 7, wherein the injection of the gasoline fuel in the premixed charge intake stroke is performed outside a cylinder head port by a gasoline injector.

9. The method as defined in claim 6, wherein the injection of the diesel fuel forms diesel droplets such that an ignition source is spatially uniformly distributed in the combustion chamber and propagation distances of gasoline flames are shortened relatively, whereas the another injection of the diesel fuel serves as an ignition trigger creating flames in the combustion chamber to form a combustion time point.

10. The method as defined in claim 9, wherein the injection of the diesel fuel is performed by directly injecting the diesel fuel into the combustion chamber using a droplet diesel injector or the another injection of the diesel fuel is performed by directly injecting a diesel fuel into the combustion chamber using an ignition diesel injector.

11. The method as defined in claim 10, wherein the droplet diesel injector and the ignition diesel injector are realized by a single diesel injector so as to be controlled at different injection timings or one injection timing.
